(19) United States
(12) Patent Application Publication
(10) Pub. No.: US 2020/0156240 A1
(43) Pub. Date: May 21, 2020

(54) CUTTING CONTROLLER

(71) Applicant: HP-PELZER-PIMSA OTOMOTIV ANONIM SIRKETI, Cayirova, Kocaeli (TR)

(72) Inventor: Rüstem YILDIZ, Kocaeli (TR)

(21) Appl. No.: 16/610,769

(22) PCT Filed: May 16, 2018
(86) PCT No.: PCT/TR2018/050239

§ 371 Date: Nov. 4, 2019

(30) Foreign Application Priority Data
Sep. 6, 2017 (TR) 2017/13105

(51) Int. Cl. B25J 9/14; B26D 5/00; B25J 11/00; B26F 3/00

(52) U.S. Cl. CPC B25J 9/14; B26F 3/004; B25J 11/0055; B26D 5/00

(57) ABSTRACT

A cutting controller which ensures faultless and/or correct cutting of mounting holes and/or edges of materials such as carpets by the nozzle that is connected to the robotic arm, wherein, it includes; at least one body, at least one solenoid valve which is connected to the body, at least one pneumatic valve which is connected to the body and opened by the compressed air in order to commence the cutting, at least one sensor which monitors and controls the motion of the solenoid valve and/or pneumatic valve.

### TECHNICAL FIELD

The invention relates to a cutting controller of a waterjet, which is used for cutting mounting holes and edges of materials such as carpets.

The invention particularly relates to a cutting controller which provides cutting standardization in order to verify that the desired cutting has been performed and/or to detect the quality of the performed cutting, by controlling the needle of the waterjet which constitutes a part of the robotic arm, using a suitable device.

### PRIOR ART

In the prior art, there is an electronic valve on the robotic arm. There is a waterjet which performs cutting with pressurized water, on the robotic arm. The needle at the end of the waterjet is raised to commence the cutting. Similarly, the needle is pushed down in order to end the cutting. The desired outline is cut out with the motion of the robotic arm. When the outline is finished, cutting process is concluded by turning off the waterjet. However, opening and closing the needle is conducted by an electronic valve. Regarding the locations of the electronic valve and the needle, there is about one meter between them. Due to this distance, commands for commencing and concluding the cutting are delayed. Most of the times, commencing is too late, while concluding is too late. Therefore, cutting the desired outline fails. A faulty cutting decrease the strength of the part. Even the lifetime shortens. Moreover, faulty cutting leads to cosmetic deformations.

Furthermore, in the prior art, the needle cannot be checked if it is opened or not. In this case, since the waterjet is not running while the robotic arm continues operating, cutting does not happen. In this case, it becomes necessary to continuously check for faulty cutting. This leads to additional costs associated to quality control. Therefore, manufacturing costs are increased. Products with failed cutting are once more put through the manufacturing process, leading to process time losses.

An example of waterjet cutting machines is given by the Chinese patent application no. CN106564094 titled “Waterjet cutting machine for automobile inner ornaments and machining method”. The present invention discloses a waterjet cutting machine for automobile inner ornaments. Waterjet cutting base comprises a supporting frame. The waterjet cutting device comprises an upper portion of the mobile device, a cutting robot, a fixing means, an image pickup device and an electronic control device, which are mounted to the machine base. The upper moving device is supported by the supporting frame and arranged above the machine seat. The upper end of the cutting robot is connected with the lower end of the upper moving device. According to the waterjet cutting machine for automobile inner ornaments, the cutting range is increased, and long workpieces can be continuously cut at a time. The electric control device is arranged outside the supporting frame. A waterjet cutting machine is disclosed in general. The invention does not disclose a cutting controller, which controls the waterjet in close proximity and checks if the cutting process is commenced or not.

Therefore, the apparent need for a cutting controller, which provides cutting standardization in order to verify that the desired cutting has been performed and/or to detect the quality of the performed cutting, by controlling the needle of the waterjet, which constitutes a part of the robotic arm, using a suitable device, and lack of an adequate solution in the background art have made it necessary to make a development in the related technical field.

### OBJECT OF THE INVENTION

The present invention relates to a cutting controller which meets aforementioned requirements, overcomes possible disadvantages, and provides further advantages.

The primary object of the cutting controller of the invention is to control the waterjet needle which performs cutting of mounting holes and edges of materials such as carpets, in order to verify that the desired cutting has been performed and/or to detect the quality of the performed cutting. The waterjet uses pressurized water to perform cutting. When the cutting commences, the pressurized water is delivered to the material which is intended to be cut. The sensor detects if the water is delivered or not and thus if the cutting process commenced or not. Thereby, cutting control is executed. After commencing the cutting, the robotic arm correctly cuts the material by performing appropriate motion. Once the cutting process of the material is finished, the pressurized water should be cut off immediately and cutting should be stopped. If the cutting is not stopped on the right time, deformations at the cutting area may result. Therefore, stopping mechanism of the cutting must be prompt. The mechanical delay between the valve and the needle is prevented by reducing the distance between the electronic valve, which is mounted on the robotic arm and turns the compressed air on and off, and the needle, which is raised when the pressure is delivered and lets the water flow and allows cutting, in order to provide the required fast stopping speed. In order to ensure this, the electronic valve is moved from the immobile part of the robotic arm to its mobile part. Moreover, the sensor checks whether the needle, which is displaced by the compressed air, is open or not. The sensor and the valve ensures correct and/or faultless cutting of the material. A cutting standardization is also ensured at the same time.

Another object of the invention is to reduce manufacturing costs by preventing time loss and/or human error. The sensors connected to the cutting controller issue warnings even when there are cutting errors. Thereby, the material that is being cut, does not undergo various check levels. Due to warnings of the sensor, at what step the error occurred can be detected promptly. This allows the error to be detected more easily and accelerates the manufacturing. Easy error detection which leads to less quality check levels and/or less error, reduces manufacturing costs.

In order to achieve aforementioned objects in the most general sense, the cutting controller, which ensures faultless and/or correct cutting of mounting holes and/or edges of materials such as carpets by the nozzle that is connected to the robotic arm, comprises a body, a solenoid valve which is connected to the body and which allows or/or blocks the compressed air, a pneumatic valve which is connected to the body and opened by the compressed air in order to commence the cutting, and a sensor which monitors and controls the motion of the solenoid valve and/or the pneumatic valve.

Structural and characteristic features of the invention and all of its advantages shall become apparent with the detailed description and the appended drawings and therefore, assessments should be based on these drawings and the detailed description.

### BRIEF DESCRIPTION OF DRAWINGS

Advantages of the present invention with its embodiment and further elements shall become apparent with reference to the drawings described below.

FIG. 1: A perspective view of the assembled cutting controller of the invention.

FIG. 2: A perspective view of the cutting controller of the invention.

FIG. 3: An exploded view of the cutting controller of the invention.

Parts References

| | |
|---|---|
| 10 | Cutting controller |
| 11 | Dual connection line |
| 12 | Robotic arm |
| 13 | Nozzle holder |
| 14 | Nozzle |
| 15 | Solenoid valve |
| 16 | Adjusting collar |
| 17 | Pneumatic valve |
| 18 | Protective cover |
| 19 | Switch |
| 20 | Sensor |
| 21 | Sensor connector |
| 22 | Adjusting leg |
| 23 | Adjusting leg connector |
| 24 | Adjusting collar connector |
| 25 | Adjusting leg connector seat |
| 26 | Adjusting collar connector seat |
| 27 | Adjusting leg insert |
| 28 | Sensor connector insert |
| 29 | Nozzle connector |
| 30 | Body |

### DETAILED DESCRIPTION OF THE INVENTION

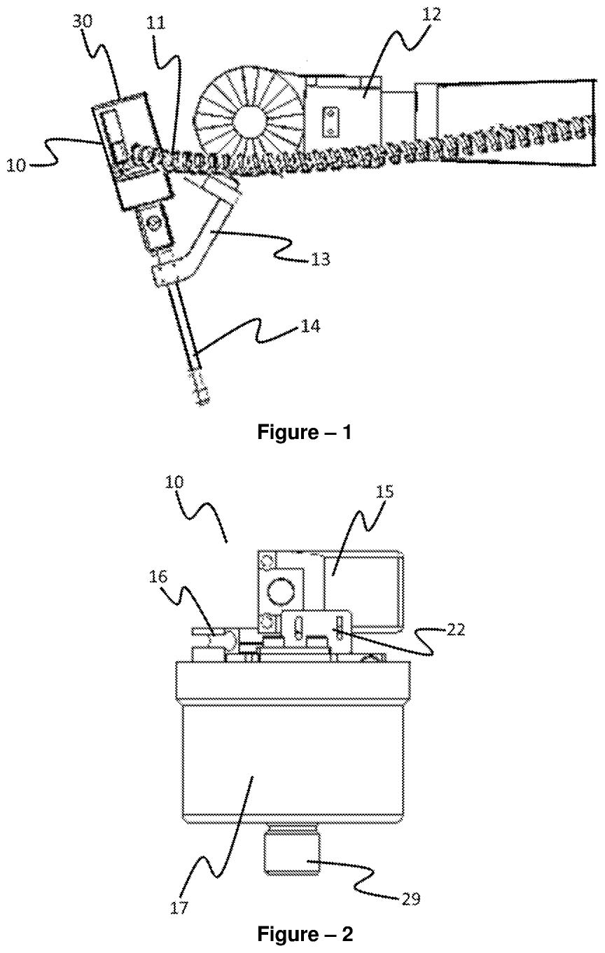

A perspective view of the assembled cutting controller (10) of the invention is given in FIG. 1. A nozzle holder (13) is attached to a robotic arm (12). The nozzle holder (13) is in connection with the nozzle (14). Thereby, the nozzle holder (13) holds the body (30). The body (30) is moved by the moving the robotic arm (12). The robotic arm (12) and the body (30) draw an outline on the material to be cut. Cutting is performed by the pressurized water from the nozzle (14), according to the outline. The nozzle (14) is connected to the pneumatic valve (17) via the nozzle connector (29). A cutting controller (10) is introduced on the pneumatic valve (17). A dual connection line (11), which is connected to the robotic arm (12), is also connected to the cutting controller (10). The dual connection line (11) comprises a structure through which electrical wiring passes, in combination with an air hose. The dual connection line (11) has a structure which is not affected by the motion of the robotic arm (12). In addition, it does not restrict the motion of the robotic arm (12). Through one side of the dual connection line (11), five electrical cables pass. Two of the electrical cables supply electrical power to the pneumatic valve (17). Remaining three cables are connected to the sensor (20). Thereby, the sensor (20) transmits information. An air hose passes through the other side of the dual connection line (11). The air passing through the air hose actuates the solenoid valve (15).

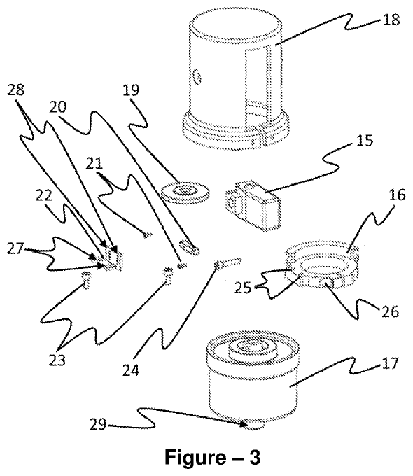

A perspective view of the cutting controller (10) of the invention is given in FIG. 2. The compressed air which comes to the solenoid valve (15), turns on the switch (19) which is attached to the solenoid valve (15). Up or down movement of the switch (19) transmits a command to the pneumatic valve (17) to open or close accordingly. An exploded view of the cutting controller (10) of the invention is given in FIG. 3. The sensor (20) monitors the motion of the switch (19) which is connected to the solenoid valve (15). After passing through a sensor connector insert (28), a sensor connector (21) is attached to the sensor (20). Thereby, the sensor (20) is secured to the adjusting leg (22). After passing through the adjusting leg insert (27), the adjusting leg connector (23) is fixed to the adjusting leg connector seat (25). Thereby, through this fixing, it becomes possible for the sensor (20) which is attached to the adjusting collar (16), to be adjusted by moving it up-down and/or forward-backward directions. An adjusting collar connector seat (26) is mounted on the adjusting collar (16). The adjusting collar connector (24) is attached to the adjusting collar connector seat (26). By clamping the adjusting collar connector (24), the adjusting collar (16) is tightly secured to the pneumatic valve (17). A protective cover (18) which is attached to the adjusting collar (16), protects the cutting controller (10) against external factors.

The compressed air coming from the solenoid valve (15) reaches the pneumatic valve (17) by raising the switch (19). When the pneumatic valve (17) is filled with compressed air, the needle which blocks the passage of water at the end of the nozzle (14) is raised upwards, letting the water flow. The water flow commences the cutting process. The upwards motion of the needle is detected by the sensor (20), which is attached to the adjusting collar (16). Data indicating the start of the cutting process is transmitted via three cables which pass through the dual connection line (11). If the needle fails to raise in 100 milliseconds, or if it fails to come down and block the water flow within the 100 milliseconds following the shutdown of the water flow, the sensor (20) warns the operator about the error by an alarm. The cutting controller (10) maintains a continuous data flow about the cutting process to the operator. Thereby, faulty and/or incorrect cutting processes are prevented. Furthermore, cost savings are achieved by accelerating the process.

1. A cutting controller which ensures faultless and/or correct cutting of mounting holes and/or edges of materials such as carpets by a nozzle that is connected to a robotic arm, wherein the cutting controller comprises:
at least one body;
at least one solenoid valve which is connected to said body, which enables compressed air to be transmitted and/or stopped;
at least one pneumatic valve which is connected to said body, which commences the cutting by being opened the compressed air; and
at least one sensor which monitors and controls the motion of said solenoid valve and/or pneumatic valve.

2. The cutting controller according to claim 1, wherein it comprises at least one switch which is controlled by the sensor, which provides opening and closing motions by using the air pressure delivered through said pneumatic valve.

3. The cutting controller according to claim 1, wherein it comprises at least one adjusting leg which allows adjusting the height and position of said sensor inside the body and which holds the sensor at the desired position.

4. The cutting controller according to claim 1, wherein it comprises at least one adjusting collar, on which said adjusting leg is attached and which allows fixing the adjusting leg.

5. The cutting controller according to claim 1, wherein it comprises at least one dual connection line, which delivers electric power to said cutting controller and compressed air to the solenoid valve, preferably comprising dual hoses, wherein one of the hoses contain five electric cables, two of which supply electricity to the pneumatic valve and other three transmit sensor information, and wherein the air through the other hose actuates the solenoid valve.

6. The cutting controller according to claim 1, wherein it comprises at least one protective cover which is attached to the pneumatic valve and forms said body in order to provide protection against external factors.

7. The cutting controller according to claim 1, wherein it comprises at least one nozzle connector which connects said pneumatic valve and the nozzle.

8. The cutting controller according to claim 1, wherein it comprises at least one nozzle holder which connects said body and nozzle to the robotic arm.
